(19) United States
(12) Patent Application Publication
(10) Pub. No.: US 2025/0147364 A1
(43) Pub. Date: May 8, 2025

(54) DISPLAY DEVICE

(71) Applicant: Japan Display Inc., Tokyo (JP)

(72) Inventor: Tenfu NAKAMURA, Tokyo (JP)

(21) Appl. No.: 18/922,665

(22) Filed: Oct. 22, 2024

(30) Foreign Application Priority Data
Nov. 6, 2023 (JP) 2023-189192

(51) Int. Cl. G02F 1/1343; G02F 1/1334; G02F 1/1362; G02F 1/1368

(52) U.S. Cl. CPC G02F 1/134309; G02F 1/1334; G02F 1/13439; G02F 1/136286; G02F 1/1368

(57) ABSTRACT

According to one embodiment, in a display device, the display panel includes pixels each including first pixels and second pixels, each of the first pixels has a transparent layer that has a refractive index lower than those of a first substrate and a second substrate and is in contact with a common electrode, each of the second pixels includes a first insulating layer that has a refractive index higher than that of the transparent layer and is in contact with the common electrode.

### CROSS-REFERENCE TO RELATED APPLICATIONS

This application is based upon and claims the benefit of priority from Japanese Patent Application No. 2023-189192, filed Nov. 6, 2023, the entire contents of which are incorporated herein by reference.

### FIELD

Embodiments described herein relate generally to a display device.

### BACKGROUND

Display devices that can switch between a scattering state, in which incident light is scattered, and a transmission state, in which incident light is transmitted, using polymer dispersed liquid crystal (PDLC) have been proposed. For transparent display devices using PDLC, an edge light mode is adopted, in which a light source is disposed in an end portion of the light guide. However, when the edge light mode is used for PDLC display devices, there is conventionally a drawback that the brightness of the display surface decreases as the distance from the light source increases.

As a solution to such a drawback, such display devices have been developed in which a light guide element including a transparent layer having a low refractive index, formed in a shape of an isosceles triangle is provided on the liquid crystal panel.

However, these display devices entail a new drawback that moiré may be created between the isosceles triangle-shaped transparent layer and pixels.

### BRIEF DESCRIPTION OF THE DRAWINGS

FIG. 1 is a plan view schematically showing a configuration of a display device of an embodiment.

FIG. 2 is a cross-sectional view schematically showing a configuration of a display panel shown in FIG. 1.

FIG. 3 is an exploded perspective view showing a main part of the display device.

FIG. 4 is a diagram schematically showing a cross-sectional configuration of the display device of the embodiment.

FIG. 5 is a diagram schematically showing a cross-sectional configuration of a display device of a comparative example 1.

FIG. 6 is a diagram schematically showing a cross-sectional configuration of a display device of a comparative example 2.

FIG. 7 is a plan view showing the arrangement of pixels in an region close to a light emitting element.

FIG. 8 is a plan view showing the arrangement of pixels in an region distant from a light emitting element.

FIG. 9 is a cross-sectional view schematically showing an example of a pixel PXL.

FIG. 10 is a cross-sectional view schematically showing an example of a pixel PXN.

FIG. 11 is a cross-sectional view schematically showing another example of the pixel PXL.

FIG. 12 is a cross-sectional view schematically showing another example of the pixel PXN. FIG. 13 is a cross-sectional view schematically showing a configuration example of a display device.

FIG. 14 is a cross-sectional view showing an example of another configuration of a display panel of the embodiment.

FIG. 15 is a cross-sectional view showing an example of another configuration of the display panel of the embodiment.

### DETAILED DESCRIPTION

In general, according to one embodiment, a display device comprises
a display panel comprising a first substrate, a second substrate, a liquid crystal layer containing a polymer dispersed liquid crystal; and
a plurality of light emitting elements,
the first substrate comprising:
a first base;
a plurality of switching elements; and
a plurality of pixel electrodes electrically connected to the plurality of switching elements, respectively,
the second substrate comprising:
a second base with a first end portion adjacent to the light emitting elements and a second end portion located at an opposite side of the first end portion from the light emitting elements; and
a common electrode opposing the plurality of pixel electrodes, wherein
the display panel comprises a plurality of pixels including a plurality of first pixels and a plurality of second pixels,
each of the plurality of first pixels includes a transparent layer that has a refractive index lower than those of the first base and the second base and is in contact with the common electrode,
each of the plurality of second pixels includes a first insulating layer that has a refractive index higher than that of the transparent layer and is in contact with the common electrode,
the display panel includes a first region and a second region,
the first region is located between the first end portion and the second region in planar view,
the second region is located between the second end portion and the first region in planar view, and
a ratio of the plurality of first pixels in the second region to the plurality of pixels is less than a ratio of the plurality of first pixels in the first region to the plurality of pixels.

According to another embodiment, a display device comprises
a display panel comprising a first substrate, a second substrate, a liquid crystal layer containing a polymer dispersed liquid crystal; and
a plurality of light emitting elements,
the first substrate comprising:
a first base;
a plurality of switching elements; and
a plurality of pixel electrodes electrically connected to the plurality of switching elements, respectively,
the second substrate comprising:
a second base with a first end portion adjacent to the light emitting elements and a second end portion located at an opposite side of the first end portion from the light emitting elements; and
a common electrode opposing the plurality of pixel electrodes, wherein
the display panel comprises a plurality of pixels including a plurality of first pixels and a plurality of second pixels,
each of the plurality of first pixels includes a transparent layer that has a refractive index lower than those of the first base and the second base and is in contact with the common electrode,
each of the plurality of second pixels includes a first insulating layer that has a refractive index higher than that of the transparent layer and is in contact with the common electrode,
the display panel includes a first region and a second region that has an area that is a same as that of the first region,
the first region is located between the first end portion and the second region in planar view,
the second region is located between the second end portion and the first region in planar view, and
a number of first pixels in the second region is less than a number of first pixels in the first region.

According to still another embodiment, a display device comprises
a display panel comprising a first substrate, a second substrate opposing the first substrate, a plurality of first pixels each containing a first pixel electrode, a plurality of second pixels each containing a second pixel electrode, and a common electrode opposing the first pixel electrode and the second pixel electrode; and
a plurality of light emitting elements, wherein
each of the plurality of first pixels includes a transparent layer that has a refractive index lower than those of the first base and the second base and is in contact with the common electrode,
each of the plurality of second pixels includes a first insulating layer that has a refractive index higher than that of the transparent layer and is in contact with the common electrode, and does not include the transparent layer,
the display panel includes a first region and a second region,
the first region is located between the first end portion and the second region in planar view,
the second area is located between the second end portion and the first region in planar view,
and
a ratio of the plurality of first pixels in the second area to the plurality of pixels is smaller than a ratio of the plurality of first pixels in the first area to the plurality of pixels.

An object of this embodiment is to provide a display device in which the degrading in image quality can be suppressed.

Embodiments will be described hereinafter with reference to the accompanying drawings. Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

The embodiments described herein are not general ones, but rather embodiments that illustrate the same or corresponding special technical features of the invention. The following is a detailed description of one embodiment of a display device with reference to the drawings.

In this embodiment, a first direction X, a second direction Y and a third direction Z are orthogonal to each other, but may intersect at an angle other than 90 degrees. The direction toward the tip of the arrow in the third direction Z is defined as up or above, and the direction opposite to the direction toward the tip of the arrow in the third direction Z is defined as down or below. Note that the first direction X, the second direction Y and the third direction Z may as well be referred to as an X direction, a Y direction and a Z direction, respectively.

With such expressions as “the second member above the first member” and “the second member below the first member”, the second member may be in contact with the first member or may be located away from the first member. In the latter case, a third member may be interposed between the first member and the second member. On the other hand, with such expressions as “the second member on the first member” and “the second member beneath the first member”, the second member is in contact with the first member.

Further, it is assumed that there is an observation position to observe the optical control element on a tip side of the arrow in the third direction Z. Here, viewing from this observation position toward the X-Y plane defined by the first direction X and the second direction Y is referred to as plan view. Viewing a cross-section of the display device in the X-Z plane defined by the first direction X and the third direction Z or in the Y-Z plane defined by the second direction Y and the third direction Z is referred to as cross-sectional view.

### Embodiment

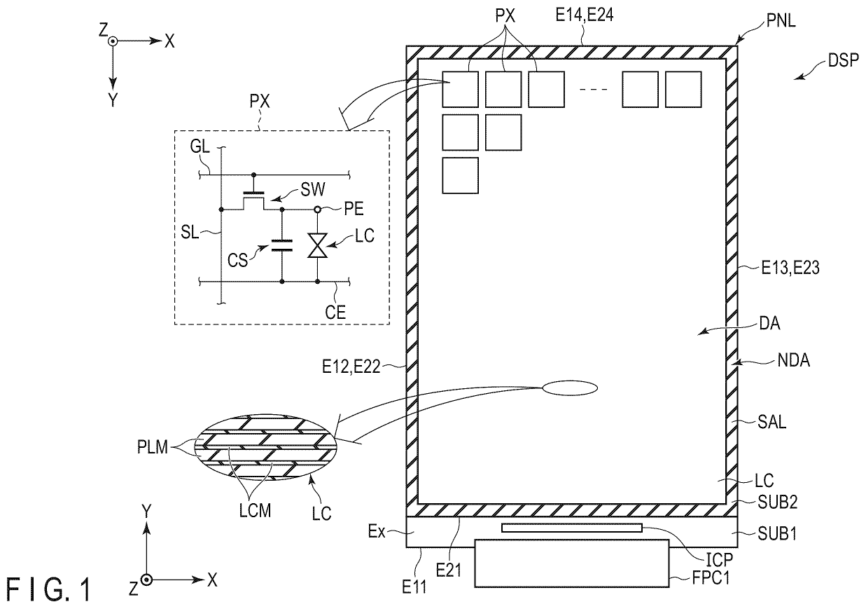

FIG. 1 is a plan view schematically showing a configuration of a display device of an embodiment.

In this embodiment, as an example of a display device DSP, a liquid crystal display device in which polymer dispersed liquid crystal is applied will be described. The display device DSP comprises a display panel PNL, an IC chip ICP, and a wiring board FPC1.

The display panel PNL comprises a substrate SUB1, a substrate SUB2, a liquid crystal layer LC, and a seal SAL. The substrate SUB1 and the substrate SUB2 are each formed into a flat plate parallel to the X-Y plane. The substrate SUB1 and the substrates SUB2 overlap each other in plan view. The substrate SUB1 and the substrate SUB2 are attached together by a seal SAL. The liquid crystal layer LC is held between the substrate SUB1 and the substrate SUB2 and sealed therein by the seal SAL.

As shown schematically in enlarged form in FIG. 1, the liquid crystal layer LC comprises polymer dispersed liquid crystal containing polymers PLM and liquid crystal molecules LCM. For example, the polymers PLM are liquid crystalline polymers. The polymers PLM are formed in a stripe shape extending along the first direction X. The liquid crystal molecules LCM are dispersed in gaps between the polymers PLM and are aligned such that their longitudinal axes are along the first direction X. Each of the polymers PLM and the liquid crystal molecules LCM has an optical anisotropy or refractive index anisotropy. The responsivity of the polymers PLM to an electric field is lower than that of the liquid crystal molecules LCM to the electric field.

For example, the alignment direction of the polymers PLM does not substantially change regardless of the presence/absence of an electric field. On the other hand, the alignment direction of the liquid crystal molecules LCM changes in response to an electric field when a voltage higher than or equal to the threshold is being applied to the liquid crystal layer LC. When no voltage is being applied to the liquid crystal layer LC, the respective optical axes of the polymers PLM and the liquid crystal molecules LCM are parallel to each other, and light entering the liquid crystal layer LC is transmitted therethrough (transparent state) without being substantially scattered in the liquid crystal layer LC. When voltage is being applied to the liquid crystal layer LC, the respective optical axes of the polymers PLM and the liquid crystal molecules LCM cross each other, and light entering the liquid crystal layer LC is scattered within the liquid crystal layer LC (scattered state).

The display panel PNL comprises a display area DA for displaying images and a frame-like non-display area NDA surrounding the display area DA. The seal SAL is located in the non-display area NDA. The display area DA comprises pixels PX arranged in a matrix along the first direction X and the second direction Y.

As shown enlarged in FIG. 1, each of the pixels PX comprises a switching element SW, a pixel electrode PE, a common electrode CE, a liquid crystal layer LC, and the like. The switching element SW is constituted by a thin-film transistor (TFT), for example, and is electrically connected to a respective scanning line GL and a respective signal line SL.

A plurality of scanning lines GL extended along the first direction X and arranged side by side along the second direction Y. One scanning line GL is electrically connected to the switching element SW in each of the pixels PX aligned along the first direction X.

A plurality of signal lines SL extend along a direction parallel to the second direction Y and are arranged side by side along the first direction X. One signal line SL is electrically connected to the switching element SW in each of the pixels PX aligned along the second direction Y. The signal lines SL intersect the scanning lines GL.

Each of the pixels PX occupies the area compartmentalized by a respective adjacent pair of signal lines SL and a respective adjacent pair of scanning lines GL. That is, the plurality of pixels PX are arranged at a predetermined pitch along each of the first direction X and the second direction Y. The pitch of the pixels PX arranged along the first direction X is equal to the pitch of the signal lines SL. The pitch of the pixels PX arranged along the second direction Y is equal to the pitch of the scanning lines GL.

The pixel electrodes PE are electrically connected to the switching elements SW, respectively. Each of the pixel electrodes PE opposes the common electrode CE, and the liquid crystal layer LC (in particular, liquid crystal molecules LCM) is driven by the electric field produced between the pixel electrode PE and the common electrode CE.

The scanning lines GL, the signal lines SL, the switching elements SW, and the pixel electrodes PE are provided on the substrate SUB1. A capacitor CS is formed, for example, between an electrode of the same potential as that of the common electrode CE and an electrode of the same potential as that of the respective pixel electrode PE.

The substrate SUB1 includes an end portion E11 and an end portion E14, which extend along the first direction X, and an end portion E12 and an end portion E13, which extend along the second direction Y. The substrate SUB2 includes an end portion E21 and an end portion E24, which extend along the first direction X, and an end portion E22 and an end portion E23, which extend along the second direction Y.

In the example illustrated in FIG. 1, the end portion E12 and the end portion E22 overlap each other in plan view, and so do the end portion E13 and the end portion E23, and the end portion E14 and the end portion E24, but may not be arranged to overlap. The end portion E21 is located between the end portion E11 and the display area DA in plan view. The substrate SUB1 includes an extended region Ex between the end portion E11 and the end portion E21.

The IC chip ICP and the circuit board FPC1 are each connected to the extended region Ex. The IC chip ICP contains, for example, a display driver built therein that outputs signals necessary for image display. The wiring board FPC1 is a flexible printed circuit board that can be bent. Note that the IC chip ICP may be connected to the wiring board FPC1. The IC chip ICP and the wiring board FPC1 read out signals from the display panel PNL in some cases, but function mainly as signal sources that supply signals to the display panel PNL.

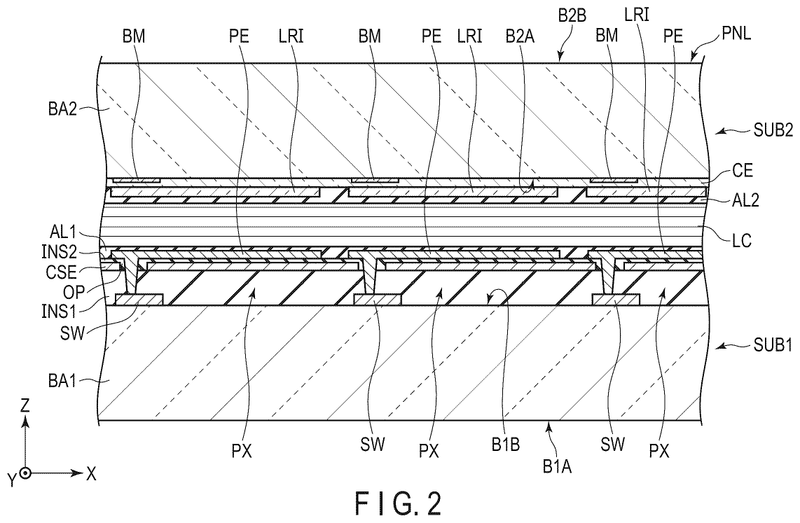

FIG. 2 is a cross-sectional view schematically showing a configuration of the display panel shown in FIG. 1.

The substrate SUBI comprises a base BAL, an insulating layer INS1, an insulating layer INS2, a capacitive electrode CSE, a switching element SW, a pixel electrode PE, and an alignment film AL1. The substrate SUB1 further comprises the scanning lines GL and signal lines SL shown in FIG. 1.

The base BAL is formed of a translucent material. The base BAL comprises a main surface (lower surface) B1A and a main surface (upper surface) B1B on an opposite side to the main surface BIA. The switching elements SW are disposed on the main surface B1B.

The insulating layer INS1 covers the switching elements SW. The capacitive electrode CSE is located between the insulating layer INS1 and the insulating layer INS2. The pixel electrode PE is provided for each pixel PX on the insulating layer INS2. The pixel electrode PE is electrically connected to the switching element SW via an opening OP formed in the capacitive electrode CSE. The pixel electrode PE overlaps the capacitive electrode CSE while interposing the insulating layer INS2 therebetween to form the capacitor CS of the pixel PX. The alignment film AL1 covers the pixel electrode PE.

The substrate SUB2 comprises a base BA2, a light-shielding layer BM, a common electrode CE, an alignment film AL2, and a transparent layer LRI.

The base BA2 is formed of a translucent material. The base BA2 comprises a main surface (lower surface) B2A and a main surface (upper surface) B2B on an opposite side to the main surface B2A. The main surface B2A of the base BA2 opposes the main surface B2B of the base BA1. The light-shielding layer BM and the common electrode CE are disposed on the main surface B2A. The light-shielding layer BM is located, for example, directly above the switching element SW and directly above the scanning line GL and the signal line SL, which are not shown in the figure.

The common electrode CE is located over a plurality of pixels PX and directly covers the light-shielding layer BM. The common electrode CE opposes the pixel electrode PE. The common electrode CE is electrically connected to the capacitive electrode CSE and is at the same potential as that of the capacitive electrode CSE. The common electrode CE may be provided for each of the plurality of pixels PX.

The transparent layer LRI is provided in contact with the common electrode CE. Details of the transparent layer LRI will be described later.

The alignment film AL2 covers the transparent layer LRI and the common electrode CE. The liquid crystal layer LC is located between the main surface B1B and the main surface B2A and is in contact with the alignment film AL1 and the alignment film AL2.

The base BAL and the base BA2 are insulating base materials such as glass or plastic. The main surface BIA, main surface B1B, main surface B2A, and main surface B2B are planes substantially parallel to the X-Y plane.

The insulating layer INS1 is formed of a transparent insulating material such as silicon oxide, silicon nitride, silicon oxynitride, acrylic resin or the like. For example, the insulating layer INS1 includes an inorganic insulating layer and an organic insulating layer. The insulating layer INS2 is an inorganic insulating layer such as of silicon nitride.

The capacitive electrode CSE, the pixel electrode PE, and the common electrode CE are transparent electrodes formed from a transparent conductive material such as indium tin oxide (ITO) or indium zinc oxide (IZO).

The light-shielding layer BM is, for example, a conductive layer having a resistance lower than that of the common electrode CE. For example, the light-shielding layer BM is formed of an opaque metal material such as molybdenum (Mo), aluminum (Al), tungsten (W), titanium (Ti), silver (Ag) or the like.

The alignment film ALI and the alignment film AL2 are horizontal alignment films having an alignment restriction force that is substantially parallel to the X-Y plane. For example, the alignment film ALI and the alignment film AL2 are subjected to alignment treatment along the first direction X. The alignment treatment may be a rubbing treatment or a photo-alignment treatment.

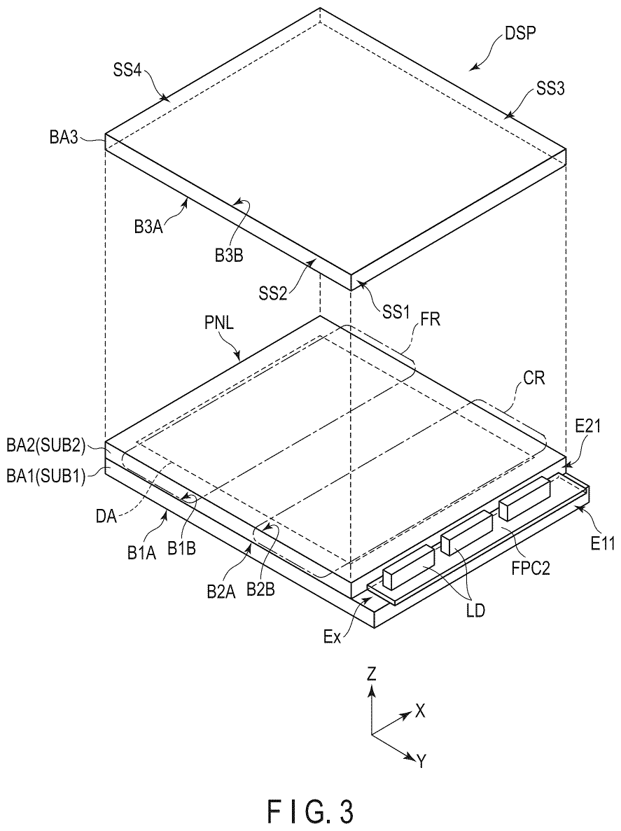

FIG. 3 is an exploded perspective view showing a main part of the display device.

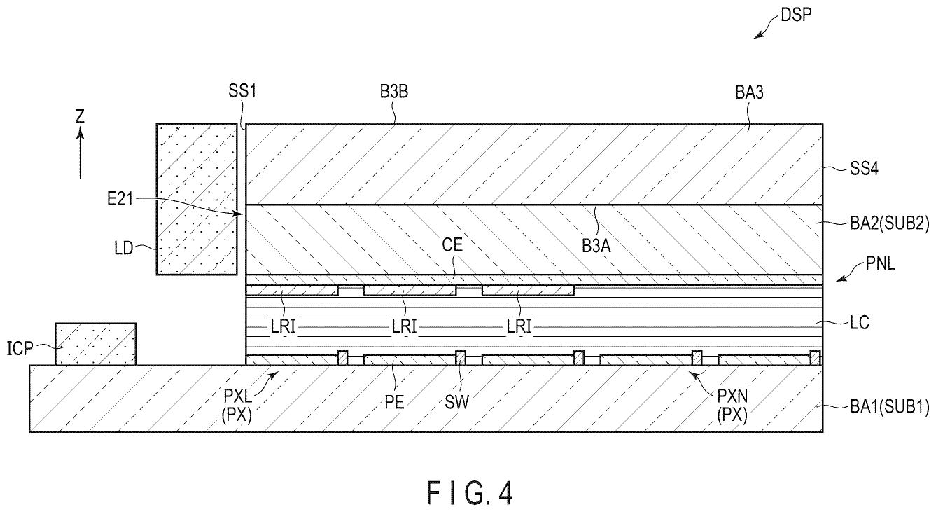

The display device DSP comprises a plurality of light emitting elements LD and a base BA3 LG in addition to the display panel PNL. The substrate SUB1, the substrate SUB2, and the base BA3 are arranged side by side in this order along the third direction Z. Note that in FIG. 3, the base BA3 is shown to be separated from the base BA2, but as shown in FIG. 4, which will be referred to later, the base BA3 is arranged in contact with the base BA2.

The plurality of light emitting elements LD are arranged to be spaced apart from each other along the first direction X. The plurality of light emitting elements LD are connected to the wiring board FPC2. The light emitting elements LD are, for example, light emitting diodes. The light emitting elements LD comprise a red light emitting element, a green light emitting element, and a blue light emitting element, which will not be described in detail though. The light emitted from the light emitting elements LD proceeds along the direction of the arrow indicating the second direction Y.

The base BA3 is formed of a translucent material. The base BA3 is an insulating base material such as glass or plastic and has a refractive index n1. For example, the base BA3 is a single base material, rather than a plurality of base materials bonded together.

The base BA3 comprises a main surface (lower surface) B3A, a main surface (upper surface) B3B on an opposite side to the main surface B3A, a first side surface SS1, a second side surface SS2, a third side surface SS3, and a fourth side surface SS4. The main surface B3A and the main surface B3B are planes substantially parallel to the X-Y plane. The main surface B3A opposes the main surface B2B of the base BA2.

The first side surface SS1 and the fourth side surface SS4 extend along the first direction X. The second side surface SS2 and the third side surface SS3 extend along the second direction Y. The first side surface SS1 and the fourth side surface SS4 oppose each other. The second side surface SS2 and the third side surface SS3 oppose each other. The second side surface SS2 and the third side surface SS3 intersect the first side surface SS1.

The plurality of light emitting elements LD are provided so as to oppose the end portion E21 of the substrate SUB2. The plurality of light emitting elements LD may be provided to oppose the first side surface SS1 of the base BA3. Note that in the example illustrated in FIG. 3, the first side surface SS1 is located directly above the end portion E21 of the substrate SUB2, but it may be located directly above the stretched region Ex or on a further outer side with respect to the end portion E11.

The base BA3 is formed, for example, of glass or an organic material such as polymethyl methacrylate (PMMA) or polycarbonate (PC).

Of the display area DA, a region close to the light emitting element LD is defined as a region CR, and a region distant from the light emitting element LD is defined as a region FR.

FIG. 4 is a diagram schematically showing a cross-sectional configuration of the display device of the embodiment. Note that in FIG. 4, among the elements of the display panel PNL shown in FIG. 2 and those of the display device DSP shown in FIG. 3, only the components necessary for explanation are shown.

As shown in FIG. 4, the transparent layer LRI is provided to be in contact with the common electrode CE. The density of the transparent layer LRI changes according to the distance from the light emitting element LD. More specifically, as the location is closer to the light emitting element LD, the number of pixels PX provided with the transparent layer LRI increases. With this configuration, in the region CR close to the light emitting element LD, the amount of light LT reflected by the transparent layer LRI is greater than the amount of light LT entering the liquid crystal layer LC.

On the other hand, as mentioned above, the area of the transparent layer LRI becomes smaller in the region FR, which is far from the light emitting element LD. With this configuration, in the region that is far from the light emitting element LD, the amount of light LT entering the display panel PNL is greater than the amount of light LT that is reflected by the transparent layer LRI.

The refractive indices of the base BAL, the base BA2, and the base BA3 are referred to as a refractive index n1, a refractive index n2, and a refractive index n3, respectively. The refractive index of the transparent layer LRI is referred to as a refractive index n4. The refractive index n4 is lower than the refractive indices n1, n2, and n3 (n4<n1, n2, n3). The refractive indices n1, n2, and n3 may be the same as each other (n1=n2=n3). In other words, the relationship: n4<n1=n2=n3 may be satisfied.

The transparent layer LRI is formed, for example, of an organic material such as a siloxane resin or a fluorine resin. Further, for example, the refractive index n3 of the base BA3 is about 1.5, and the refractive index n4 of the transparent layer LRI is about 1.0 to 1.4. When the refractive indices n1, n2, and n3 are the same as each other, the refractive index n1 of the base BAL and the refractive index n2 of the base BA2 as well are about 1.5.

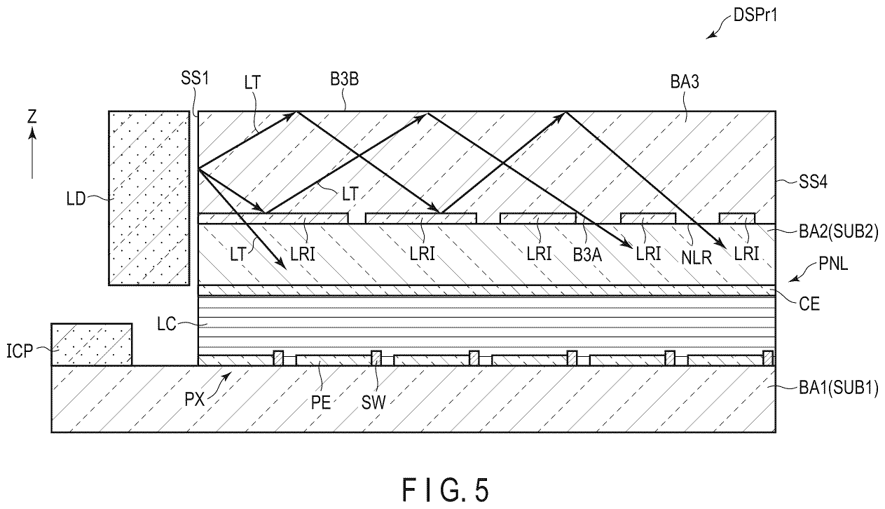

FIG. 5 is a diagram schematically showing a cross-sectional configuration of a display device of Comparative Example 1. In a display device DSPrl shown in FIG. 5, the transparent layer LRI is provided on an outer side of the display panel PNL, not on an inner side thereof. More specifically, the transparent layer LRI is provided between the base BA2 and the base BA3 of the display panel PNL. The light emitting element LD is provided to be adjacent to the first side surface SS1 of the base BA3.

The light LT emitted from the light emitting element LD enters the first side surface SS1 of the base BA3. The light LT that enters the first side surface SS1 is guided in through the base BA3 while being reflected by the main surface B3B and the transparent layer LRI. The main surface B3B is an interface between the base BA3 and an air layer.

As described above, the light LT is reflected by the main surface B3B and the transparent layer LRI. However, when the light LT passes through a region NLRI of the main surface B3A, where the transparent layer LRI is not provided, it enters the display panel PNL through the region NLR. The light LT may as well enter the display panel PNL through the transparent layer LRI.

By reflecting with the transparent layer LRI, the light LT can be guided from the first side surface SS1, which is the entering surface, to the fourth side surface SS4, which opposes to the first side surface SS1. The light LT that has entered the display panel PN1 in the region NLRI is diffused or transmitted in the liquid crystal layer LC of the display panel PN1. With this configuration, the image is displayed on the display device DSP.

Now, let us refer back to FIG. 4. Here, even in the case of the display device DSP, in which the transparent layer LR1 is provided inside the display panel PNL, more specifically, in the pixels PX, the light emitted from the light emitting element LD and entering the display device DSP is guided towards the fourth side surface SS4 while being reflected by the transparent layer LRI.

As described above, it is possible to control the aperture ratio by controlling the area occupied by the transparent layer LRI in each pixel PX. However, between the region of each pixel where the transparent layer LRI is provided and the region where the transparent layer LRI is not provided, a difference of cell gap is created in the display panel PNL. When a cell gap difference is created in the display panel PNL, the display quality of the display device DSP will deteriorate.

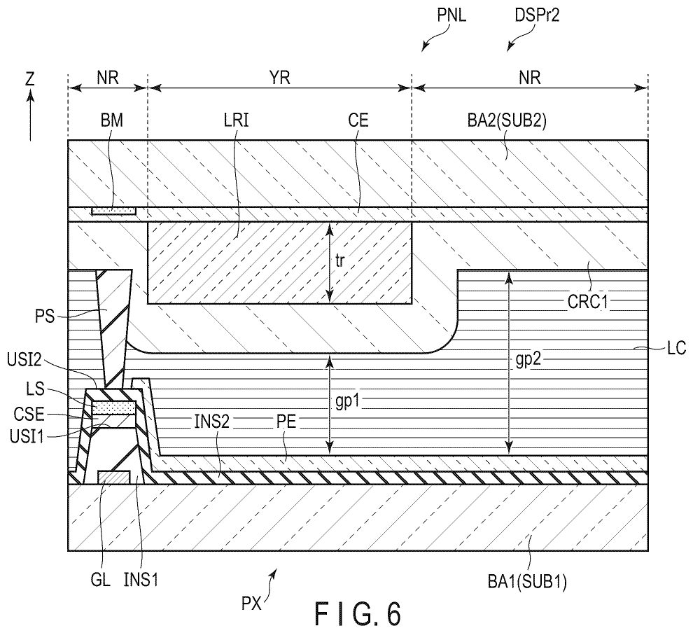

FIG. 6 is a diagram schematically showing a cross-sectional configuration of a display device of Comparative Example 2. FIG. 6 shows a cross-sectional view of one pixel PX of a display device DSPr2 of Comparative Example 2. In the display device DSPr2, there are regions where the transparent layer LRI is provided within the pixel PX and where no transparent layer LRI is provided as shown in FIG. 5, and as in the case of the display device DSP shown in FIG. 4, the transparent layer LRI is provided within the display panel PNL.

The display device DSPr2 includes a substrate SUB1, a substrate SUB2, and a liquid crystal layer LC. The substrate SUB1 comprises a base BAL, a scanning line GL, an insulating layer INS2, a capacitive electrode CSE, a light shielding layer LS, and a pixel electrode PE in each pixel.

The scanning line GL, which is provided on the base BAL, is covered by the insulating layer INS1. An upper surface USI1 of the insulating layer INS1 is a planarized surface. The capacitive electrode CSE and the light shielding layer LS are provided in contact with the upper surface USI1 of the insulating layer INS1.

The insulating layer INS2 is provided to cover the insulating layer INS1, the capacitive electrode CSE, and the light shielding layer LS. The pixel electrode PE is provided in contact with the insulating layer INS2. The planarized upper surface USI2 of the insulating layer INS2 is disposed on the upper surface USI1 of the insulating layer INS1.

The substrate SUB2 includes a base BA2, a light shielding layer BM, a common electrode CE, a transparent layer LRI, and an insulating layer CRC1.

The light shielding layer BM, which is provided on the base BA2, opposes the scanning line GL. The common electrode CE is provided to cover the base BA2 and the light shielding layer BM. The transparent layer LRI is provided in contact with a part of the common electrode CE. The insulating layer CRC1 is provided to cover the transparent layer LRI and the common electrode CE.

The insulating layer CRC1 is formed of a transparent insulating material such as silicon oxide, silicon nitride, silicon oxynitride, or acrylic resin, as in the case of the insulating layer INS1. For example, the insulating layer CRC1 includes an inorganic insulating layer and an organic insulating layer. The refractive index of the insulating layer CRC1 is higher than that of the transparent layer LRI. With the insulating layer CRC1 thus provided, the peeling-off of the transparent layer LRI can be inhibited.

Between the upper surface USI2 of the insulating layer INS2 and the insulating layer CRC1, a spacer PS is disposed. The spacer PS has the function of maintaining the distance (cell gap) between the substrate SUB1 and the substrate SUB2. It suffices if the spacer PS is formed, for example, from a photosensitive resin material.

The thickness of the transparent layer LRI is defined as a thickness tr. The distance between the pixel electrode PE and the insulating layer CRC1, and the distance between the pixel electrode PE and the transparent layer LRI, are defined as cell gaps gp. The cell gap in the region YR where the transparent layer LRI is provided is defined as a cell gap gp1, and the cell gap in the region NR where the transparent layer LRI is not provided is defined as a cell gap gp2.

The cell gap gp2 is longer than the cell gap gp1 by the thickness tr of the transparent layer LRI. The thickness tr, the cell gap gp1, and the cell gap gp2 can merely be, for example, 1 μm, 3 μm, and 3.5 μm or more and 4.0 μm or less, respectively.

As described above, the difference between the cell gap gp2 and the cell gap gp1 is, for example, 0.5 μm or more and 1.0 μm or less. If a difference in cell gap is created within the pixel PX, the effective electric field strengths differ therebetween. In such a case, even when the same voltage is applied between the pixel electrode PE and the common electrode CE, the electric field strength will differ between the region YR and the region NR. As a result, the luminances of the region YR and the region NR will be different from each other, and there is a risk that the display quality of the display device DSPr2 may deteriorate.

In the display device of this embodiment, as shown in FIG. 4, pixels PXL with a transparent layer LRI and pixels PXN without a transparent layer LRI are arranged in the display area DA. In the region CR close to the light emitting element LD, the ratio of pixels PXL is increased, and in the region FR distant from the light emitting element LD, the ratio of pixels PXN is increased. In the pixel PXN, an insulating layer CR1 having the same thickness as that of the transparent layer LRI is formed. With this configuration, it is possible to vary the area of the transparent layer LRI while maintaining the cell gap at constant across the display area DA.

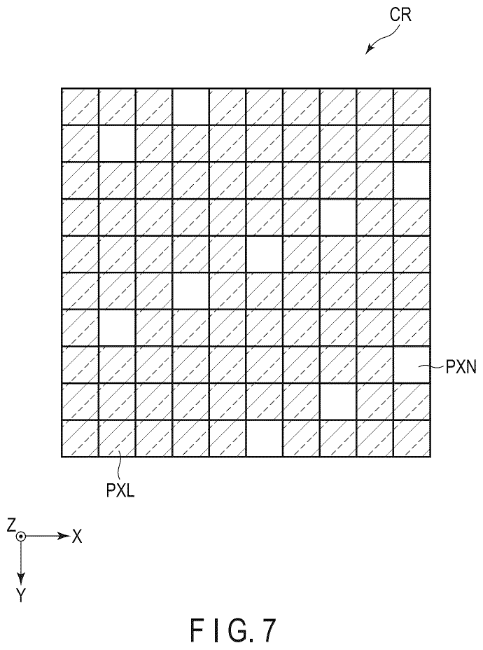

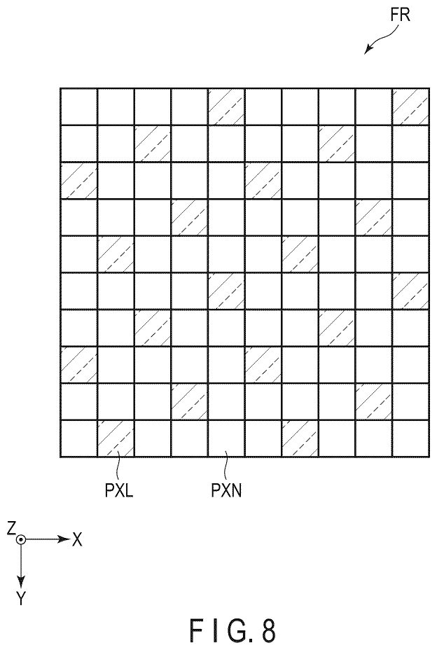

FIG. 7 is a plan view showing the arrangement of pixels in the region close to the light emitting element. FIG. 8 is a plan view showing the arrangement of pixels in the region distant from the light emitting element.

In the region CR shown in FIG. 7, the number of pixels PXL, which are provided with the transparent layer LRI is greater than the number of pixels PXN, which are not provided with the transparent layer LRI. For example, in the region CR shown in FIG. 7, out of one hundred pixels PX, the number of pixels PXL is 90 (ninety), and the number of pixels PXN is 10 (ten). In other words, the ratio of pixels PXL is 90%, and the ratio of pixels PXN is 10%.

On the other hand, in the region FR shown in FIG. 8, the number of pixels PXL, which are provided with the transparent layer LRI is less than the number of pixels PXN, which are not provided with the transparent layer LRI. For example, in the region FR shown in FIG. 8, out of one hundred pixels PX, the number of pixels PXL is 20 (twenty) and the number of pixels PXN is 80 (eighty). In other words, the ratio of pixels PXL is 20%, and the ratio of pixels PXN is 80%.

In each of the region CR and the region FR, it is preferable that those of a smaller number of the pixels PXL or PXN should be evenly distributed. That is, in the region CR, it is preferable that the pixels PXN should be scattered and interspersed. Or, it is preferable that the pixels PXN are arranged at a fixed distance from each other. Similarly, in the FR region, it is preferable for the pixels PXL to be scattered and sparsely distributed. Or, it is preferable for the pixels PXL to be arranged at a fixed distance from each other. This is because if those of a smaller number of the pixels PXL and PXN are arranged in a locally concentrated manner, the part where they are arranged will be more easily visible, and this will result in a decrease in display quality.

As the distance from the light emitting element LD increases, the number of pixels PXL decreases and the number of pixels PXN increases. Here, it is preferable that the number of pixels PXL decreases in steps. When the number of pixels PXL decreases suddenly, the luminance also changes suddenly, which may as well cause a deterioration in display quality.

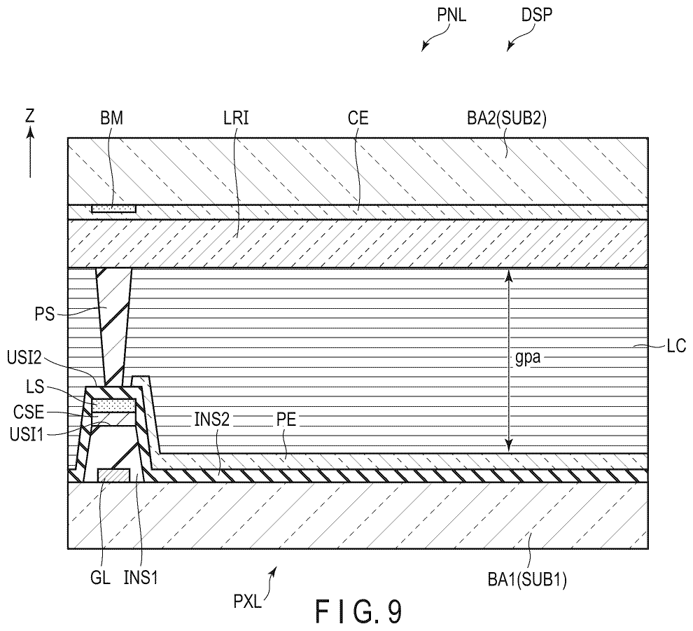

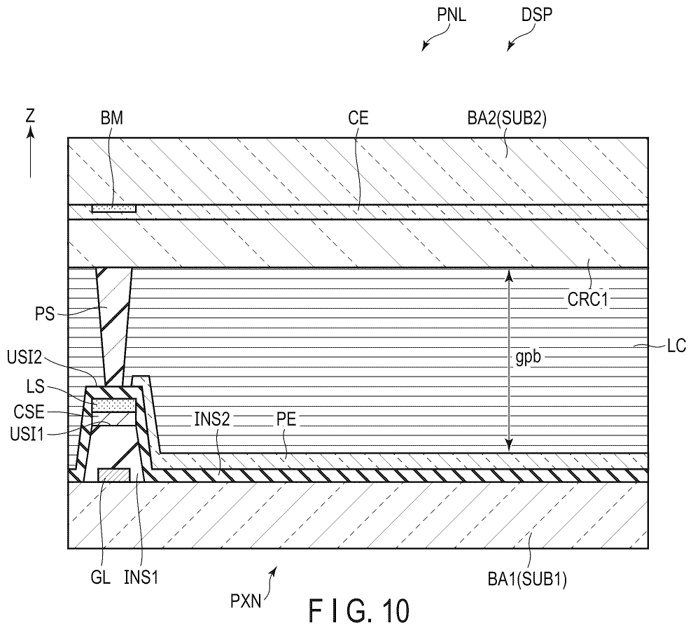

FIG. 9 is a cross-sectional view schematically showing an example of the pixel PXL. FIG. 10 is a cross-sectional view schematically showing an example of the pixel PXN. With regard to FIGS. 9 and 10, the substrate SUB1 has a configuration similar to those shown in FIG. 6.

In the pixel PXL, the transparent layer LRI is provided in contact with the common electrode CE on the substrate SUB2, but the insulating layer CRC1 is not provided (see FIG. 9). On the other hand, in the pixel PXN, the insulating layer CRC1 is provided in contact with the common electrode CE on the substrate SUB2, but the transparent layer LRI is not provided (see FIG. 10). Note here that the area of the region where the transparent layer LRI is provided in the pixel PXL and the area of the region where the insulating layer CRC1 is provided in the pixel PXN should preferably be the same as each other.

It is also preferable that the thickness of the transparent layer LRI provided in the pixel PXL and the thickness of the insulating layer CRC1 provided in the pixel PXN should be the same.

Here, in the pixel PXL, the distance between the transparent layer LRI and the pixel electrode PE is defined as a cell gap gpa. In the pixel PXN, the distance between the insulating layer CRC1 and the pixel electrode PE is defined as a cell gap gpb. The cell gap gpa and the cell gap gpb are the same as each other.

Since the cell gap gpa and the cell gap gpb are the same, the electric field strength at the pixel PXL and pixel PXN is constant. Therefore, it is possible to suppress the deterioration of the display quality of the display device DSP.

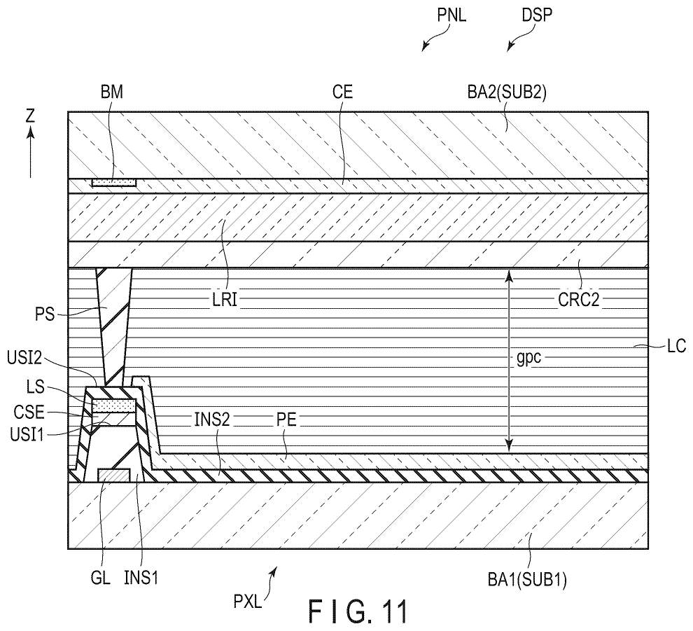

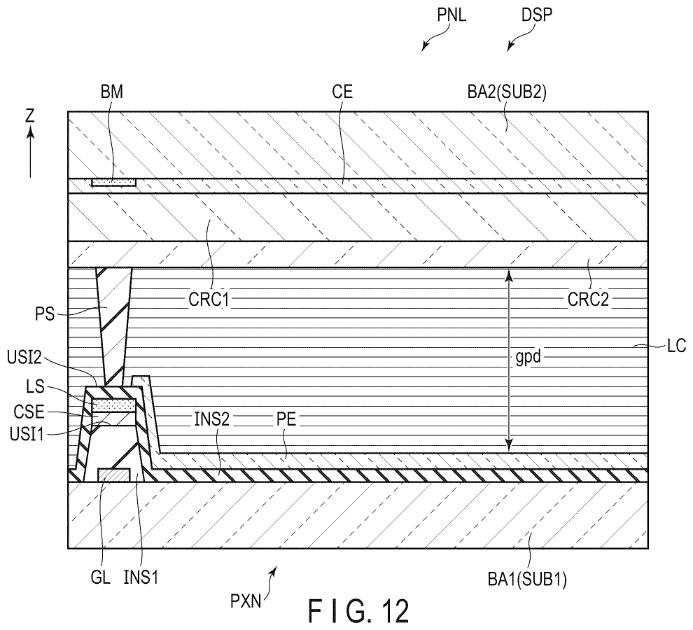

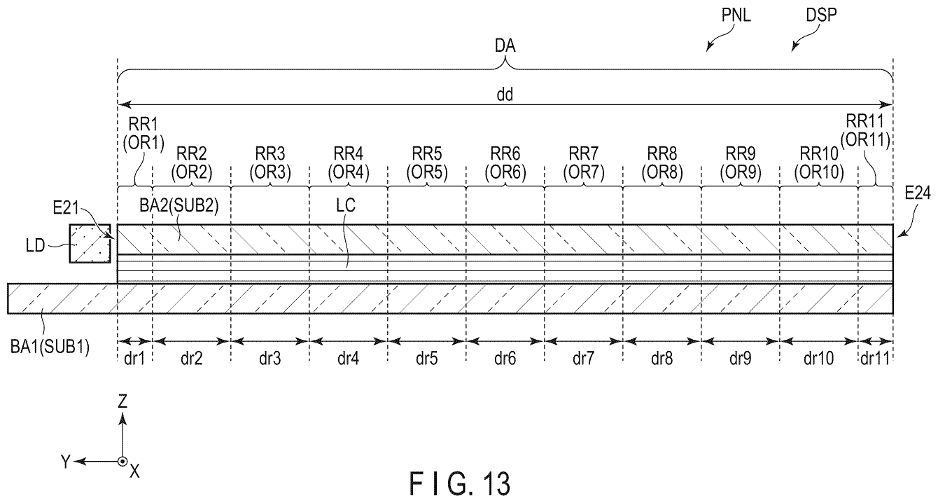

In the configuration examples shown in FIGS. 9 and 10, a new insulating layer may be provided in contact with the transparent layer LRI and the insulating layer CRC1. FIG. 11 is a cross-sectional view schematically showing another example of the pixel PXL. FIG. 12 a cross-sectional view schematically showing another example of the pixel PXN. The configuration examples shown in FIGS. 11 and 12 are different from the configuration examples shown in FIGS. 9 and 10 in that the insulating layer CRC2 is provided in contact with the transparent layer LRI and the insulating layer CRC1.

In FIG. 11, the insulating layer CRC2 is formed to cover the transparent layer LRI. With the insulating layer CRC2 provided to cover the transparent layer LRI, it is possible to prevent the transparent layer LRI from being peeled off from the common electrode CE. Further, it is also possible to promote the planarization of the substrate SUB2 and set the cell gap gpc and the cell gap gpd, which will be described later, to the same as each other.

In the pixel PXL shown in FIG. 11, the distance between the insulating layer CRC2 and the pixel electrode PE is defined as a cell gap gpc. In the pixel PXN shown in FIG. 12, the distance between the insulating layer CRC2 and the pixel electrode PE is defined as a cell gap gpd. The cell gap gpc and the cell gap gpd are the same as each other.

In the pixel PXL, the insulating layer CRC2 is provided in addition to the transparent layer LRI, and in the pixel PXN as well, the insulating layer CRC2 is provided in addition to the insulating layer CRC1. The insulating layer CRC2 provided in the pixel PXL and the pixel PXN need have the same thickness. With this configuration, the cell gap gpc of pixel PXL and the cell gap gpc of the pixel PXN can be made identical to each other. Therefore, as in the case of FIGS. 9 and 10, it is also possible to suppress a deterioration in the display quality of the display device DSP having the pixels shown in FIGS. 11 and 12, as well.

Here, it suffices if the insulating layer CRC2 is formed of the material used for the insulating layer CRC1 described above. The insulating layer CRC2 may as well be formed of the material used for the insulating layer CRC1, or it may be formed of a different material. When the insulating layer CRC1 and the insulating layer CRC2 are made of the same material, the insulating layer CRC1 and the insulating layer CRC2 of the pixel PXN may be formed to be integrated as one body.

FIG. 13 is a cross-sectional view schematically showing a configuration example of a display device. In the display device DSP shown in FIG. 13, only the configuration elements necessary for explanation are shown, and other elements are omitted.

In FIG. 13, the display area DA of the display device DSP is divided into, for example, 11(eleven) regions from an end portion E21 to an end portion E24 of the substrate SUB2. That is, the display area DA is divided into 11 (eleven) regions from the side adjacent to the light emitting element LD to the side farthest from the light emitting element LD. It can be said that the display area DA include, from the side adjacent to the light emitting element LD, a region RR1, a region RR2, a region RR3, a region RR4, a region RR5, a region RR6, a region RR7, a region RR8, a region RR9, a region RR10, and a region RR11.

The aperture ratios of the regions RR1, RR2, RR3, RR4, RR5, RR6, RR7, RR8, RR9, RR10, and RR11 are, respectively, referred to as an aperture ratio OR1, an aperture ratio OR2, an aperture ratio OR3, an aperture ratio OR4, an aperture ratio OR5, an aperture ratio OR6, an aperture ratio OR7, an aperture ratio OR8, an aperture ratio OR9, an aperture ratio OR10, and an aperture ratio OR11.

When the region RR1 to the region RR11 are not distinguished from each other, they are simply referred to as the regions RR. When the aperture ratio OR1 to the aperture ratio OR11 are not distinguished from each other, they are simply referred to as the aperture ratios OR. The number of regions RR is not limited to 11 (eleven). As the number of regions RR is more, the change in the aperture ratio OR becomes smoother. When the change in the aperture ratio OR becomes smoother, the display quality improves. However, due to manufacturing constraints such as manufacturing costs, the number of regions RR may possibly be limited. The number of regions RR can be determined as appropriate in consideration of the display quality and manufacturing constraints.

The aperture ratio ORI to the aperture ratio OR11 are each the ratio of the region where the transparent layer LRI is not provided in the region RR1 to the region RR11, respectively. In other words, it can as well be said that it is the ratio of the pixels PXN with respect to all the pixels PX. The aperture ratio OR may as well be equivalent to the number of pixels PXN with respect to the total number of pixels PX in the region RR. Or, it may as well be the area occupied by the pixels PXN with respect to the area occupied by all the pixels PX in the region RR.

The aperture ratio ORI to the aperture ratio OR11 should preferably change smoothly as described above. Ideally, the aperture ratio OR should increase continuously, but if it cannot be increased continuously in terms of manufacturing, the ratio should only be increased in steps.

Here, the overall length of the display area DA along a direction parallel to the second direction Y is referred to as a length dd. The lengths of the regions RR1, RR2, RR3, RR4, RR5, RR6, RR7, RR8, RR9, RR10, and RR11 along a direction parallel to the second direction Y are, respectively, referred to as a length dr1, a length dr2, a length dr3, a length dr4, a length dr5, a length dr6, a length dr7, a length dr8, a length dr9, a length dr10, and a length dr11, respectively.

For example, when the aperture ratios OR1, OR2, OR3, OR4, OR5, OR6, OR7, OR8, OR9, OR10, and OR 11 are 0%, 10%, 20%, 30%, 40%, 50%, 60%, 70%, 80%, 90%, and 100%, respectively, the ratios of the length dr1, length dr2, length dr3, length dr4, length dr5, length dr6, length dr7, length dr8, length dr9, length dr10, and length dr11, should be, respectively, set to 5%, 10%, 10%, 10%, 10%, 10%, 10%, 10%, 10%, 10%, and 5%. In other words, the lengths of the region RR1 and the region RR11 are each set to 5% of the total length, that is, the length dd, and the lengths of the region RR2 to region RR10 are each set to 10% of the total length, that is, the length dd.

For example, the aperture ratio OR2 of the region RR2 is 10%. The pixels PXL and the pixels PXN of the region RR2 should be arranged as explained with reference to FIG. 7. Similarly, for example, the aperture ratio OR9 of the region RR9 is 80%. The pixels PXL and the pixels PXN of the region RR9 should be arranged as explained with reference to FIG. 8.

Further, in the regions RR adjacent to each other, those of a less number of pixels PX of the pixels PXL and pixels PXN should be scattered and sparsely distributed. This is because if those of a less number of pixels PX are arranged in a regionally concentrated manner at the boundary of the regions RR adjacent to each other, the portion of the arrangement becomes easier to visually recognizable, which may cause a deterioration in display quality.

In the display device DSP of this embodiment, the ratio occupied by the transparent layer LRI is reduced from the side adjacent to the light emitting element LD to the side that is farther away. With this configuration, in the region close to the light emitting element LD, the ratio of light LT from the light emitting element LD, which is reflected by the transparent layer LRI increases, and the light LT propagates toward the side that is farther away from the light emitting element LD. On the side that is distant from the light emitting element LD, the ratio occupied by the transparent layer LRI is small, and therefore the ratio of light LT that enters the pixel PX is large. As a result, the light LT becomes uniform across the display area DA.

In the pixels PXN where the transparent layer LRI is not provided, the insulating layer CRC1 is provided in place of the transparent layer LRI. With this configuration, the cell gap of the pixels PXL where the transparent layer LRI is provided and the cell gap of the pixels PXN where the transparent layer LRI is not provided become uniform. As a result, it is possible to suppress the deterioration in display quality.

### Configuration Example 1

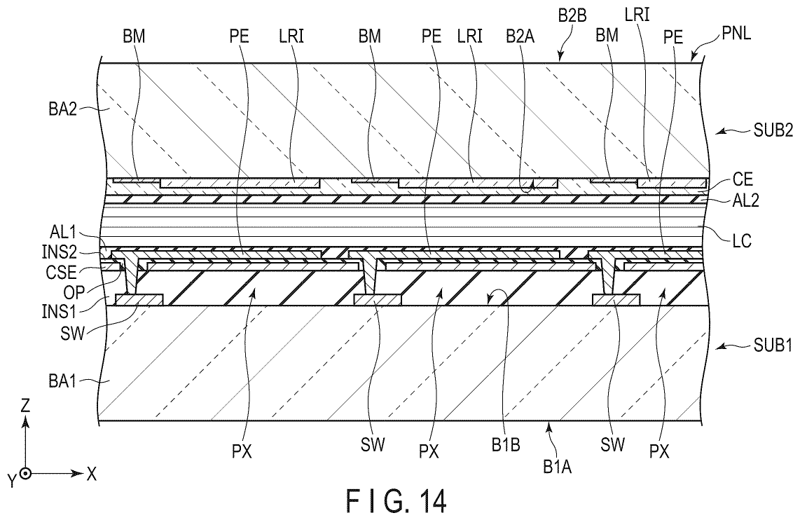

FIG. 14 is a cross-sectional view showing another example of the configuration of the display panel of the embodiment. The display panel PNL shown in FIG. 14 is different from the display panel PNL shown in FIG. 2 in that the transparent layer LRI is provided in the same layer as that of the light shielding layer BM.

The transparent layer LRI is arranged on the main surface B2A as in the case of the light shielding layer BM. The common electrode CE is arranged to cover the transparent layer LRI and the light shielding layer BM. The alignment film AL2 is arranged to cover the common electrode CE.

This configuration example as well exhibits advantageous effects similar to those of the embodiment.

### Configuration Example 2

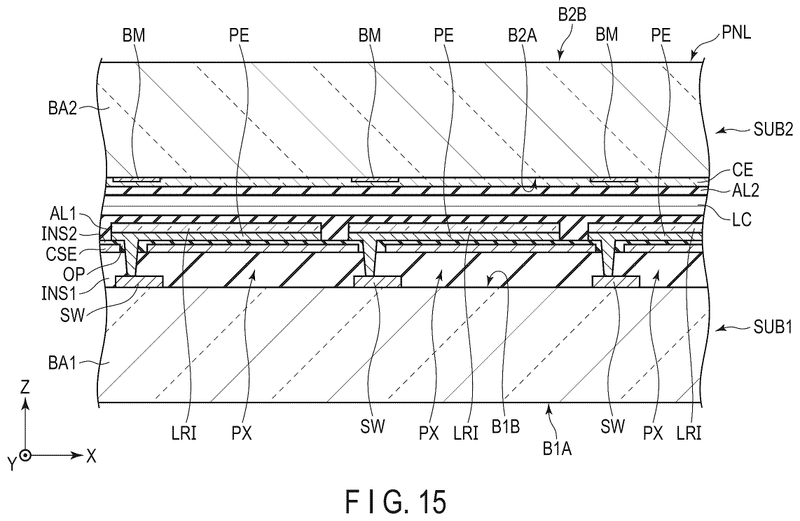

FIG. 15 is a cross-sectional view showing another example of the configuration of the display panel of the embodiment. The display panel PNL shown in FIG. 15 is different from the display panel PNL shown in FIG. 2 in that the transparent layer LRI is provided between the pixel electrode PE and the alignment film AL2.

In FIG. 15, the transparent layer LRI is provided in contact with the pixel electrode PE. The alignment layer AL1 is provided to cover the pixel electrode PE, the transparent layer LRI, and the insulating layer INS2. Note here that the transparent layer LRI is not limited to that of this example, but may be provided, for example, between the alignment layer AL1 and the alignment layer AL2.

This configuration example as well exhibits advantageous effects similar to those of the embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a display panel comprising a first substrate, a second substrate, a liquid crystal layer containing a polymer dispersed liquid crystal; and
a plurality of light emitting elements,
the first substrate comprising:
a first base;
a plurality of switching elements; and
a plurality of pixel electrodes electrically connected to the plurality of switching elements, respectively,
the second substrate comprising:
a second base with a first end portion adjacent to the light emitting elements and a second end portion located at an opposite side of the first end portion from the light emitting elements; and
a common electrode opposing the plurality of pixel electrodes, wherein
the display panel comprises a plurality of pixels including a plurality of first pixels and a plurality of second pixels,
each of the plurality of first pixels includes a transparent layer that has a refractive index lower than those of the first base and the second base and is in contact with the common electrode,
each of the plurality of second pixels includes a first insulating layer that has a refractive index higher than that of the transparent layer and is in contact with the common electrode,
the display panel includes a first region and a second region,
the first region is located between the first end portion and the second region in planar view,
the second region is located between the second end portion and the first region in planar view, and
a ratio of the plurality of first pixels in the second region to the plurality of pixels is less than a ratio of the plurality of first pixels in the first region to the plurality of pixels.

2. The display device according to claim 1, wherein
a number of the plurality of first pixels decreases from the first end portion to the second end portion.

3. The display device according to claim 1, wherein
an area of the plurality of first pixels decreases from the first end portion to the second end portion.

4. The display device according to claim 1, further comprising:
a second insulating layer in contact with the transparent layer and the first insulating layer, and having a refractive index higher than that of the transparent layer.

5. The display device according to claim 1, further comprising:
a third base in contact with the second substrate, having a refractive index that is a same as those of the first base and the second base.

6. The display device according to claim 1, wherein
the transparent layer is made of a siloxane resin or a fluorine resin.

7. The display device according to claim 1, wherein
a refractive index of the first base and the second base is 1.5, and a refractive index of the transparent layer is 1.0 to 1.4.

8. The display device according to claim 1, wherein
a refractive index of the third base is 1.5.

9. The display device according to claim 1, wherein
the first substrate comprises:
a plurality of scanning lines provided on the first base, extending along a first direction and aligned along a second direction that intersects the first direction, and
a plurality of signal lines provided on the first base, extending along the second direction and aligned along the first direction,
wherein the plurality of switching elements electrically connected to the plurality of scanning lines and the plurality of signal lines.

10. The display device according to claim 1, wherein
when a distance between the transparent layer and the pixel electrode is defined as a first cell gap, and a distance between the first insulating layer and the pixel electrode is defined as a second cell gap,
the first cell gap and the second cell gap are a same as each other.

11. A display device comprising:
a display panel comprising a first substrate, a second substrate, a liquid crystal layer containing a polymer dispersed liquid crystal; and
a plurality of light emitting elements,
the first substrate comprising:
a first base;
a plurality of switching elements; and
a plurality of pixel electrodes electrically connected to the plurality of switching elements, respectively,
the second substrate comprising:
a second base with a first end portion adjacent to the light emitting elements and a second end portion located at an opposite side of the first end portion from the light emitting elements; and
a common electrode opposing the plurality of pixel electrodes, wherein
the display panel comprises a plurality of pixels including a plurality of first pixels and a plurality of second pixels,
each of the plurality of first pixels includes a transparent layer that has a refractive index lower than those of the first base and the second base and is in contact with the common electrode,
each of the plurality of second pixels includes a first insulating layer that has a refractive index higher than that of the transparent layer and is in contact with the common electrode,
the display panel includes a first region and a second region that has an area that is a same as that of the first region,
the first region is located between the first end portion and the second region in planar view,
the second region is located between the second end portion and the first region in planar view, and
a number of first pixels in the second region is less than a number of first pixels in the first region.

12. The display device according to claim 11, further comprising:
a second insulating layer having a refractive index higher than that of the transparent layer and being in contact with each of the first insulating layer and the transparent layer.

13. The display device according to claim 11, further comprising:
a third base having a refractive index that is a same as those of the first base and the second base and being in contact with the second substrate.

14. The display device according to claim 11, wherein
when a distance between the transparent layer and the pixel electrode is defined as a first cell gap, and a distance between the first insulating layer and the pixel electrode is defined as a second cell gap,
the first cell gap and the second cell gap are a same as each other.

15. A display device comprising:
a display panel comprising a first substrate, a second substrate opposing the first substrate, a plurality of first pixels each containing a first pixel electrode, a plurality of second pixels each containing a second pixel electrode, and a common electrode opposing the first pixel electrode and the second pixel electrode; and
a plurality of light emitting elements, wherein
each of the plurality of first pixels includes a transparent layer that has a refractive index lower than those of the first base and the second base and is in contact with the common electrode,
each of the plurality of second pixels includes a first insulating layer that has a refractive index higher than that of the transparent layer and is in contact with the common electrode, and does not include the transparent layer,
the display panel includes a first region and a second region,
the first region is located between the first end portion and the second region in planar view,
the second area is located between the second end portion and the first region in planar view,
and
a ratio of the plurality of first pixels in the second area to the plurality of pixels is smaller than a ratio of the plurality of first pixels in the first area to the plurality of pixels.

16. The display device according to claim 15, wherein
when a distance between the transparent layer and the pixel electrode is defined as a first cell gap, and a distance between the first insulating layer and the pixel electrode is defined as a second cell gap,
the first cell gap and the second cell gap are a same as each other.

17. The display device according to claim 15, wherein
each of the plurality of first pixels includes a second insulating layer in contact with the transparent layer,
the transparent layer is located between the common electrode and the second insulating layer,
each of the plurality of second pixels includes a third insulating layer in contact with the first insulating layer, and
the first insulating layer is located between the common electrode and the third insulating layer.

18. The display device according to claim 15, wherein
the second insulating layer and the third insulating layer are located in a same layer.

19. The display device according to claim 17, wherein
a thickness of the transparent layer and a thickness of the first insulating layer are same as each other, and
a thickness of the second insulating layer and a thickness of the third insulating layer are same as each other.
